(19) United States
(12) Patent Application Publication
(10) Pub. No.: US 2017/0111540 A1
(43) Pub. Date: Apr. 20, 2017

(54) TO SELECT A PRINT MODE

(71) Applicant: HEWLETT-PACKARD DEVELOPMENT COMPANY, L.P., Houston, TX (US)

(72) Inventors: Antonio Gracia Verdugo, Barcelona (ES); Francisco Javier Perez Gellida, Sant Cugat del Valles (ES); Oriol Borrell Avila, Sabadell (ES)

(21) Appl. No.: 15/127,153

(22) PCT Filed: Apr. 4, 2014
(86) PCT No.: PCT/EP2014/057083

§ 371 Date: Nov. 8, 2016

(51) Int. Cl. H04N 1/23; H04N 1/50; H04N 1/60; B41J 29/38

(52) U.S. Cl. CPC H04N 1/2369; B41J 29/38; H04N 1/2338; H04N 1/50; H04N 1/6058

(57) ABSTRACT

A method to select a print mode in which a first image comprising a plurality of pixels is received. Color depth for at least a subset of the plurality of pixels of the first image is determined. A print mode is selected from a plurality of print modes using at least the determined color depth.

### BACKGROUND

Printer apparatus are usually arranged to deposit printing material (such as ink or toner) on media. The printer apparatus may have a variety of print modes that may be selected by a user to alter the output of the printer. For example, a first print mode may configure the printer to print an image relatively quickly and with low quality. By way of another example, a second print mode may configure the printer to print an image relatively slowly and with high quality.

### BRIEF DESCRIPTION

Reference will now be made by way of example only to the accompanying drawings in which:

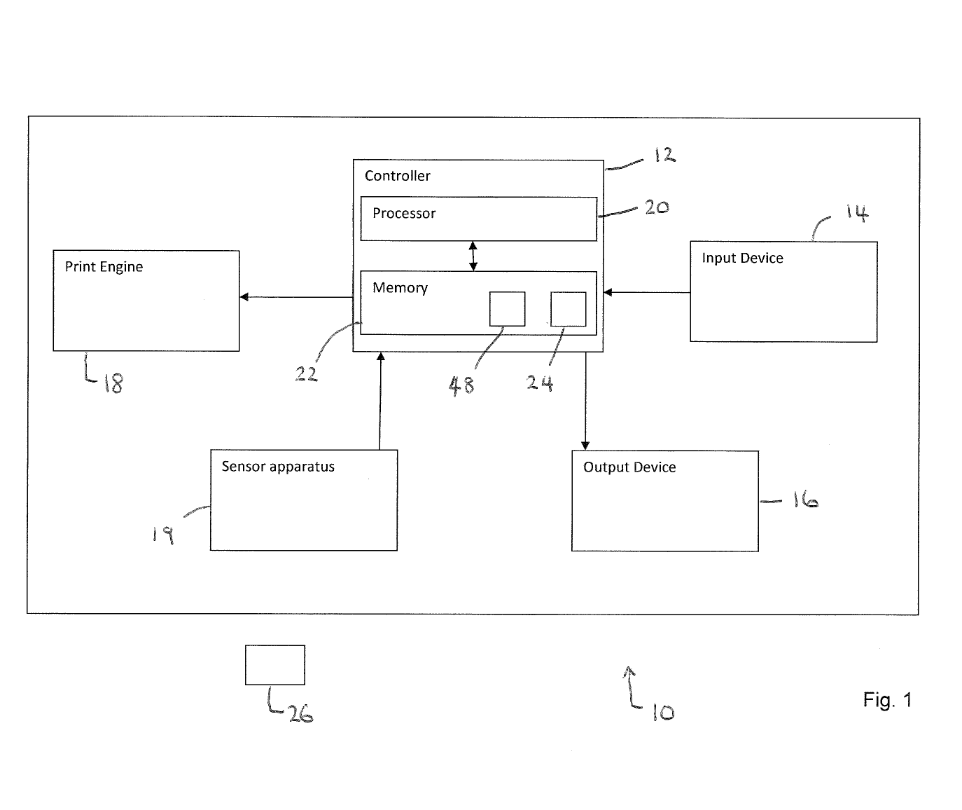

FIG. 1 illustrates a schematic diagram of an apparatus according to an example;

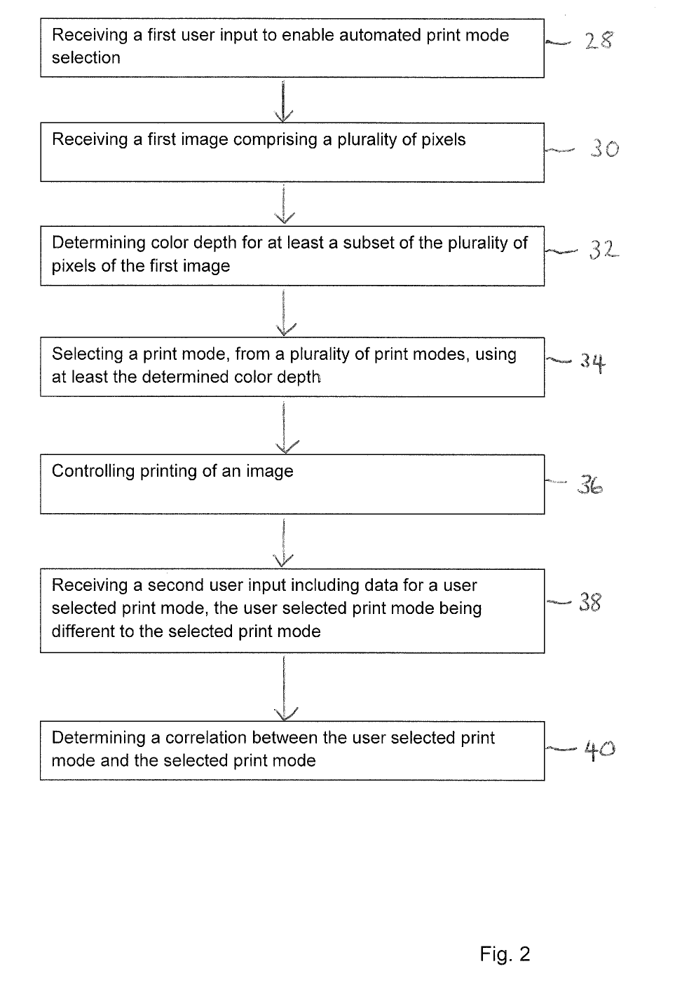

FIG. 2 illustrates a flow diagram of a method according to an example;

FIG. 3 illustrates a first look up table according to an example; and

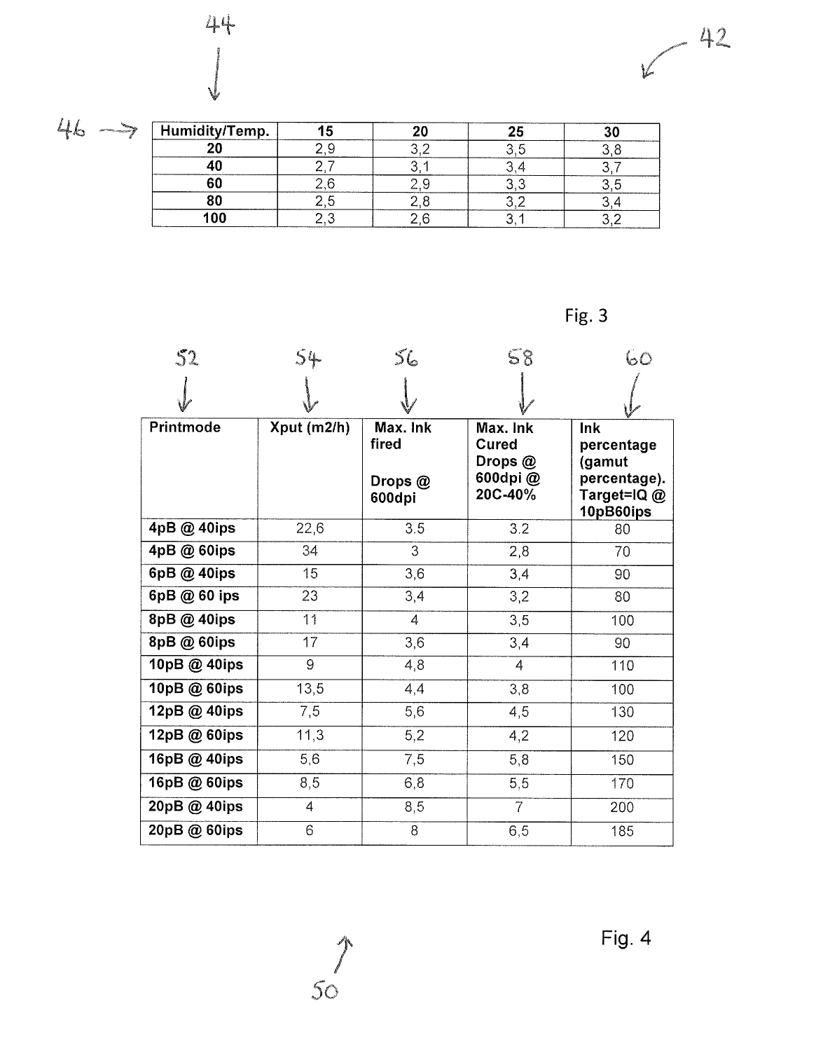

FIG. 4 illustrates a second look up table according to an example.

### DETAILED DESCRIPTION

FIG. 1 illustrates a schematic diagram of an apparatus 10 (which may also be referred to as a printer apparatus 10) including a controller 12, an input device 14, an output device 16, a print engine 18 and sensor apparatus 19. The apparatus 10 may be any suitable printer apparatus and may be, for example, a latex printer, an inkjet printer, a laser printer and so on. In some examples, the apparatus 10 may be a module. As used herein, the term ‘module’ refers to a unit or apparatus that excludes certain parts or components that would be added by an end manufacturer or a user. For example, where the apparatus 10 is a module, the apparatus 10 may comprise the controller 12 and the remaining components of the apparatus 10 (namely, the input device 14, the output device 16, the print engine 18 and the sensor apparatus 19) may be added by another manufacturer.

The implementation of the controller 12 can be in hardware alone (for example, a circuit and/or a processor and so on), have certain aspects in software including firmware alone or can be a combination of hardware and software (including firmware).

The controller 12 may be implemented using instructions that enable hardware functionality, for example, by using executable computer program instructions 24 in a general-purpose or special-purpose processor 20 that may be stored on a computer readable storage medium 22 (disk, memory and so on) to be executed by such a processor 20.

The processor 20 is configured to read from and write to the memory 22. The processor 20 may also comprise an output interface via which data and/or commands are output by the processor 20 and an input interface via which data and/or commands are input to the processor 20.

The memory 22 stores a computer program 24 comprising computer program instructions that control the operation of the apparatus 10 when loaded into the processor 20. The computer program instructions 24 provide the logic and routines that enables the apparatus 10 to perform the methods illustrated in FIG. 2. The processor 20 by reading the memory 22 is able to load and execute the computer program 24.

The computer program may arrive at the apparatus 10 via any suitable delivery mechanism 26. The delivery mechanism 26 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 24. The delivery mechanism 26 may be a signal configured to reliably transfer the computer program 24. The apparatus 10 may propagate or transmit the computer program 24 as a computer data signal.

The input device 14 may be any suitable apparatus that is arranged to enable a user to provide an input to the apparatus 10. For example, the input device 14 may form part of a touch screen display, and/or may include at least one button. The controller 12 is arranged to receive a user control signal from the input device 14.

The output device 16 may be any suitable apparatus that is arranged to provide information to the user of the apparatus 10. For example, the output device 16 may form part of a touch screen display, and/or may include at least one loudspeaker for providing acoustic signals to the user. The controller 12 is arranged to control the output device to provide information to the user.

The print engine 18 may be any suitable apparatus for depositing printing material (for example, ink (such as latex ink, solvent ink, ultra-violet curable ink), toner and so on) on media. In some examples, the media may be a substrate such as (but not limited to) paper or vinyl. In other examples, the apparatus 10 may be a three dimensional printer and the media may include a layer of build material, such as a powder-based build material, on a moveable support. For example, the print engine 18 may include a plurality of rollers for transferring toner to media. By way of another example, the print engine 18 may include inkjet printer apparatus. The controller 12 is arranged to control the print engine 18 to print an image (which may include text and/or pictures) on media.

The sensor apparatus 19 includes at least one sensor to sense at least one parameter that affects the formation (that is, curing, drying and so on) of the printing material on the media. For example, where the printing material is latex, the parameters that affect the curing of latex on media may include ambient temperature, ambient humidity, and media type. By way of an example, the sensor apparatus 19 may include a temperature sensor to determine the ambient temperature external to the apparatus 10, and/or a humidity sensor to determine the ambient humidity external to the apparatus 10, and/or a sensor to determine the type of media to be printed on. The controller 12 is arranged to receive data from the sensor apparatus 19 for the least one parameter.

The operation of the apparatus 10 is described in the following paragraphs with reference to FIG. 2.

At block 28, the controller 12 receives a first user input from the input device 14 to enable automated print mode selection. In some examples, the controller 12 may control the output device 16 to provide an ‘automated print mode’ option to a user (which may be accompanied by print modes that the user may select). The user may operate the input device 14 to select the ‘automated print mode’ option. In other examples, the first input to enable automated print mode selection may be received from a printer driver instead of a printer user interface.

For example, the controller 12 may control the output device 16 to display a graphical user interface that provides a list of available print modes, including an option ‘automated print mode selection’. The user may not wish, or have the experience, to select a print mode themselves, and they therefore use the input device 14 to select the ‘automated print mode’ option to enable the apparatus 10 to automatically select the most appropriate print mode for the image they wish to print.

In some examples, the controller 12 may control the output device 16 to request from the user whether automatic print mode selection should prioritize printing speed, the gamut of colors to be used when printing, or a balance of the printing speed and the gamut of colors. The user may operate the input device 14 to select one of the options, and the user's selection may be used to assist with the selection of a print mode in block 34.

At block 30, the controller 12 receives a first image comprising a plurality of pixels. The first image may include text and/or pictures. The first image may be received from a raster image processor which may be part of the controller 12, or may be separate to the controller 12. In some examples, the first image is a lower resolution copy (such as, a thumbnail image) of a second image (where the second image is the image to be printed by the apparatus 10). In other examples, the first image may be the image to be printed by the apparatus 10.

At block 32, the controller 12 determines color depth for at least a subset of the plurality of pixels of the received first image. The color depth defines the color of a pixel and where the color depth has a higher value, the more intense the color of the pixel. For example, the ‘color depth’ may be defined by numerical values for red, green and blue (RGB) where ‘deeper’ colors have higher values of red, green and blue. The controller 12 may determine the “pixel image RGB color value”, which is then converted to “printing pixel value and depth” using at least one look up table. For example, in a “image pixel” (or average of a portion, and so on) with RGB color of “XXX”, the “printing pixel” has “a” drops of cyan, “b” drops of magenta, “c” drops of light cyan, no drop for K (black). The combination of a+b+c and so on constitutes the depth of the “printing pixel value and depth”.

At block 34, the controller 12 selects a print mode, from a plurality of print modes, using at least the determined color depth.

The controller 12 determines a quantity of printing material that is required to achieve the color depth determined in block 32. For example, where a color depth of a pixel is relatively high, a relatively large amount of printing material may be required to achieve that color on the media. In some examples, the controller 12 may determine the color depth that has the highest value and then determine the quantity of printing material that is required to achieve that color depth. By way of an example, where the printing material is latex ink, the controller 12 may determine the color depth that has the highest value and then determine the number of drops of latex ink that are required to achieve that color depth when deposited on the media. The controller 12 may use a look up table (stored in the memory 22 for example) to determine the quantity of printing material that is required to achieve a determined color depth.

In one example, the controller 12 receives the first image (a jpg file in this example) from a raster image processor and then performs RGB analysis to determine values for red, green and blue. Next, the controller 12 converts the RGB values to CMYK (cyan, magenta, yellow, black) values. Next, the controller 12 converts the CMYK values to ink density values (that is, an ICC (International Color Consortium) profile). Subsequently, the controller 12 converts the ink density values to an ink map including device color separation values that indicate the number of ink drops to be deposited on media. The controller 12 may use at least one lookup table to perform the conversions mentioned in this paragraph.

The controller 12 then selects the print mode that will enable the print engine 18 to deposit at least the determined quantity of printing material on the media, and that will enable the deposited printing material to form (for example, cure or dry) on the media. As described in the following paragraphs, the controller 12 may use at least one look up table to select a print mode for printing.

In some examples, the controller 12 may additionally use data from the sensor apparatus 19 to select a print mode. In some examples, the controller 12 may use data for the media type, ambient temperature and ambient relative humidity to select a print mode since each of these external factors may affect the rate at which printing material forms on the media. For example, the curing rate of latex increases with increasing ambient temperature, and decreases with increasing ambient relative humidity.

At block 36, the controller 12 controls the printing of the image using the print mode selected in block 34. In some examples, the controller 12 controls the print engine 18 to print the second image on the media (where the first image is a lower resolution copy of the second image). In other examples, the controller 12 controls the print engine 18 to print the first image on the media (where the first image is the image to be printed).

At block 38, the controller 12 may receive a second user input including data for a user selected print mode, different to the print mode selected by the controller 12 in block 34. Before or after printing of the image (that is, before or after block 36), the controller 38 may control the output device 16 to inform the user of the print mode selected in block 34, and enable the user to provide feedback on the selected print mode. For example, the output device 16 may inform the user that a relatively fast, low quality print mode has been selected and request the user to provide their feedback on the selection. In response, the user may operate the input device 14 to indicate that the print mode selected in block 34 is acceptable, or may provide feedback to change the print mode selected in block 34 (for example, to a slower, higher quality print mode). Where block 38 is performed prior to block 36, the controller 12 may use the user selected print mode when controlling the print engine 18 to print the image.

At block 40, the controller 12 may determine a correlation between the user selected print mode (provided by the user in block 38) and the selected print mode (selected by the controller 12 in block 34). In other words, the controller 12 may determine the relationship between the user selected print mode and the selected print mode. For example, where a user selects a print mode having a lower printing speed and higher quality than the print mode selected in block 34, the controller 12 determines the correlation that the user prefers higher quality print output (at the expense of printing speed and printing output). In some examples, the controller 12 may then store the correlation in the memory 22 so that when another image is received for printing, the stored correlation is used when selecting the print mode in block 34 to select a higher quality print mode. In other examples, the controller 12 may use the determined correlation to adjust the settings of the print modes. For example, where the controller 12 determines that the user prefers higher quality print output (with lower throughput), the controller 12 may adjust all of the print modes to provide a higher quality print output. By way of another example, where the controller 12 determines that the user prefers higher throughput of media (with lower quality print output), the controller 12 may adjust all of the print modes to provide a higher throughput.

The apparatus 10 may provide several advantages. Firstly, the apparatus 10 may be relatively simple to use since the user is presented with an ‘automated print mode’ setting which, if selected, causes the apparatus 10 to select a print mode for printing an image. Secondly, since the operation of the apparatus 10 may not require user intervention, the apparatus 10 may be relatively productive at printing. Thirdly, where the print mode is selected based on color depth (and therefore the quantity of printing material required to print a pixel), the apparatus 10 may provide a reliable printed output since substantially all printing material is formed (for example, cured) on the media.

FIG. 3 illustrates a first look up table 42 for curing capacity of a maximum amount of ink per 600 horizontal dots per inch (dpi) per pixel where the ink is fully cured, depending on ambient relative humidity and ambient temperature. The media is a vinyl substrate and the print mode is 10 pB at 60 ips (inches per second). The image is to be printed at 600 dpi (horizontal dots per inch)×1200 dpi (vertical dots per inch). The first look up table 42 may be stored in the memory 22 as indicated by reference numeral 48.

In more detail, the first look up table 42 includes a first column 44 for ambient relative humidity, and a first row 46 for ambient temperature. As can be seen in FIG. 3, for a constant ambient temperature, the curing capacity of latex ink decreases with increasing ambient relative humidity. For a constant ambient relative humidity, the curing capacity of latex increases with increasing ambient temperature.

FIG. 4 illustrates a second look up table 50 for the print modes available to the apparatus 10 according to an example. The table 50 includes a first column 52 for print modes, a second column 54 for rate of output of media (in meters squared per hour), a third column for the maximum amount of ink that may be deposited by the print engine 18 (where the printing resolution is 600 dots per inch (dpi)), a fourth column 58 for the maximum amount of ink that may be cured (where the printing resolution is 600 dots per inch, the ambient temperature is 20 Celsius, and the ambient relative humidity is 40%), and a fifth column 60 for the gamut percentage compared to one of the print modes (10 pB 60 ips in this example).

In operation, the controller 12 may use the look up tables 42 and 50 in block 34 to select a print mode for printing an image. For example, the controller 12 may determine that a first image has a maximum amount of total ink drops of 3.9 for a pixel. In other examples, the controller 12 may determine instead that a first image has an average amount of total ink drops for a portion of the image, or may use another method.

The controller 12 uses the look up table 50 to determine that the print mode having the highest productivity with the lowest loss of gamut versus the optimum reference is 10 pB 40 ips. The controller 12 then uses a look up table similar to the look up table illustrated in FIG. 3 to determine whether the ambient conditions (that is, temperature and humidity) enable the maximum ink quantity to cure. If the maximum latex drop of 3.9 will cure with the sensed ambient conditions, the controller 12 selects the 10 pB 40 ips print mode. If the maximum latex drop of 3.9 will not cure with the sensed ambient conditions, the controller 12 selects an alternative print mode whereby the maximum latex drop of 3.9 will cure at those ambient conditions.

Consequently, the controller 12 advantageously selects a print mode to maximize the relationship between throughput of media and gamut. The controller 12 may be considered to take into account worst case scenarios to provide robust print modes that provide optimal throughput and gamut. The controller 12 maximizes the relationship between throughput and gamut by knowing what is going to be printed and the printer capabilities.

For example, a relatively fast print mode (6 pB 60 ips) is limited in the maximum ink deposited onto the substrate (and therefore the gamut is limited) because in the worst case scenario, areas of media fill with a lot of ink and the apparatus 10 may not be able to cure the ink if it is determined that more gamut is required. If it is determined that more gamut is required, the controller 12 may select a print mode that has a higher number of passes of the print head.

If it is determined to print areas of the media with relatively low ink in that print mode (6 pB), the media may appear faded because the apparatus 10 may provide robust printing on all areas to ensure the curing of ink on the media.

If it is determined to print those areas of the media with the optimum throughput-gamut relationship that the apparatus 10 is able to provide (that is, increasing the gamut (ink fired) at the same printing speed), the controller 12 may use, for example, the ink fired in the 8 pB print mode, but control printing with an 6 pB print mode, because the controller 12 has determined that the apparatus 10 will be able to cure the ink.

The blocks illustrated in the FIG. 2 may represent steps in a method and/or sections of code in the computer program 24. The illustration of a particular order to the blocks does not necessarily imply that there is a required or preferred order for the blocks and the order and arrangement of the block may be varied in some examples. Furthermore, it may be possible for some blocks to be omitted in some examples.

Although examples have been described in the preceding paragraphs, it should be appreciated that modifications to the examples given can be made without departing from the scope as claimed. For example, the methodology used either to analyze the image and/or to translate the information to the printer may be based on maximum amount of printing material, average amount of printing material, a mathematical function, and so on.

Although the processor 20 is illustrated as a single component it may be implemented as one or more separate components some or all of which may be integrated/removable and/or may provide permanent/semi-permanent/dynamic/cached storage.

Although the memory 22 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ and so on, or a ‘controller’, ‘computer’, ‘processor’ and so on should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code and so on should be understood to encompass software for a programmable processor or firmware such as, for example, the programmable content of a hardware device whether instructions for a processor, or configuration settings for a fixed-function device, gate array or programmable logic device and so on.

Features described in the preceding description may be used in combinations other than the combinations explicitly described.

Although functions have been described with reference to certain features, those functions may be performable by other features whether described or not.

Although features have been described with reference to certain examples, those features may also be present in other examples whether described or not.

Whilst endeavoring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

What is claimed is:

1. A method to select a print mode, the method comprising:
receiving a first image comprising a plurality of pixels;
determining color depth for at least a subset of the plurality of pixels of the first image; and
selecting a print mode, from a plurality of print modes, using at least the determined color depth.

2. A method as claimed in claim 1, further comprising controlling printing of the first image using the selected print mode.

3. A method as claimed in claim 1, further comprising controlling printing of a second image using the selected print mode, the first image being a lower resolution copy of the second image.

4. A method as claimed in claim 1, further comprising receiving a first user input to enable automated print mode selection.

5. A method as claimed in claim 1, further comprising receiving a second user input including data for a user selected print mode, the user selected print mode being different to the selected print mode.

6. A method as claimed in claim 5, further comprising determining a correlation between the user selected print mode and the selected print mode.

7. A method as claimed in claim 6, further comprising selecting a print mode using the determined correlation and determined color depth of another image.

8. An apparatus to determine a print mode, the apparatus comprising:
a controller to:
analyze a first image to determine color depth for at least a part of the first image; and
determine a print mode using at least the determined color depth to print an image.

9. An apparatus as claimed in claim 8, wherein the controller is to control printing of the first image using the determined print mode.

10. An apparatus as claimed in claim 8, wherein the controller is to control printing of a second image using the determined print mode, the first image being a lower resolution copy of the second image.

11. An apparatus as claimed in claim 8, wherein the controller is to receive a first user input to enable automated print mode selection.

12. An apparatus as claimed in claim 8, wherein the controller is to receive a second user input including data for a user selected print mode, the user selected print mode being different to the determined print mode.

13. An apparatus as claimed in claim 12, wherein the controller is to determine a correlation between the user selected print mode and the selected print mode.

14. An apparatus as claimed in claim 13, wherein the controller is to determine a print mode using the determined correlation and determined color depth of another image.

15. A non-transitory computer-readable storage medium encoded with instructions that, when performed by a processor, cause performance of:
receiving a first image comprising a plurality of pixels;
determining color depth for at least a subset of the plurality of pixels of the first image; and
selecting a print mode, from a plurality of print modes, using at least the determined color depth.
